(19) United States
(12) Patent Application Publication
(10) Pub. No.: US 2006/0041741 A1
(43) Pub. Date: Feb. 23, 2006

(54) Systems and methods for IP level decryption

(75) Inventors: Topi Pohjolainen, Helsinki (FI); Eero Jyske, Vantaa (FI); Matti Puputti, Turku (FI); Timo Karras, Espoo (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/923,079

(22) Filed: Aug. 23, 2004

(51) Int. Cl. H04L 9/00

(52) U.S. Cl. 713/150

(57) ABSTRACT

Methods and systems for delivering decrypted Internet Protocol (IP) packets are described. The method for delivery comprises steps of receiving a request from an application for IP packets associated with a first IP address/port pair; receiving IP packets associated with a different IP address/port pair; extracting decryption information from the IP packets associated with the different IP address/port pair; decrypting the encrypted IP packets associated with the first IP address/port pair based upon the extracted decryption information; and transmitting the decrypted IP packets associated with the first IP address/port pair to the application. The decryption information may include decryption key(s) and/or properties/parameters and may be independent of the application.

### FIELD OF THE INVENTION

The invention relates generally to a system and method for decryption of encrypted IP packets. More specifically, the invention provides a method and system for IP level conditional access decryption without an application supplying encryption details for the decryption.

### BACKGROUND OF THE INVENTION

TCP/IP (Transmission Control Protocol/Internet Protocol) is the basic communication language or protocol of the Internet and may be used as a communications protocol in a private network, either an intranet or an extranet. TCP/IP is a networking protocol that allows various computers with differing hardware and software architectures within a plurality of networks to communicate with each other. TCP/IP is generally described by a protocol stack model that describes various functions of the stack into layers. As described below, FIG. 1 is an example model 100 of such a protocol stack model. The model is described as a stack because software modules are stacked on top of each other for interaction purposes.

TCP/IP is often described using four functional layers, although the actual Transmission Control protocol and Internet Protocol subsets are generally run at two of the four layers. As shown in FIG. 1, a layer, such as Application Layer 101, identifies a function for data communication that may be performed by any of a number of protocols. TCP/IP communication is primarily point-to-point or peer-to-peer, meaning each communication is from one point or host computer in the network to another point or host computer where each point or host computer is implementing the same protocol at an equivalent layer of the protocol stack. TCP/IP communication is standardized for proper communication.

Transmission Control Protocol (TCP) assembles a message or data into smaller packets that are transmitted over a network, such as the Internet, and eventually received by a TCP layer in a destination computer that reassembles the packets into the original message or data. Internet Protocol (IP) addresses each packet so that the packets get to the correct destination. Intermediate computers on the network check the IP address to determine where to forward the package. Each packet from an original message may be routed differently to the destination computer, but eventually they are reassembled at the same destination.

FIG. 1 illustrates a block diagram of an example protocol stack model 100. The protocol stack model 100 includes four layers of function: an application layer 101, a transport layer 103, an internetwork layer 105, and a network interface layer 107. The top layer of the protocol stack model 100 is the application layer 101. Application layer 101 manages the functions required by the user program and is highly specific to the operating application. All user oriented access protocols are maintained within the application layer 101. Functions for interacting with the transport layer 103 are maintained within the application layer 101. Application layer 101 also includes functions directed to data encryption and decryption in addition to data compression and decompression. The most widely recognized TCP/IP application layer protocols include Hypertext Transfer Protocol (HTTP), the File Transfer Protocol (FTP), Telnet, and the Simple Mail Transfer Protocol (SMTP). Application layer 101 may also include such protocols as Domain Name Service (DNS), the Routing Information Protocol (RIN), the Simple Network Management Protocol (SNMP), and Network File System (NFS).

Transport layer 103 includes the TCP subset. Transport layer 103 maintains protocols for end-to-end connectivity and data integrity. Transport layer 103 provides error control capability. Transport layer 103 provides detection of and recover from lost, duplicated, or corrupted packets of data. In the transport layer 103, data from the application layer 101 is divided into packets each with a sequence number that indicates the order of the packets in a block. As each packet is received by the transport layer 103 of a destination computer, the destination transport layer 103 examines the packet and, when a complete sequence of packets are received, sends an acknowledgement (ACK) signal to the source computer indicating the next expected sequence number. Transport layer 103 includes TCP and User Datagram Protocol (UDP). UDP is used instead of TCP for special purposes. Other protocols may be maintained in the transport layer 103. Transport layer 103 is also responsible for moving data between the application layer 101 and the internetwork layer 105.

Internetwork layer 105 includes the IP subset. Internetwork layer 105 maintains protocols for routing messages or data through internetworks. Internetwork layer 105 attempts to deliver every packet of data but does not retransmit lost or corrupted packets. Gateways and routers are responsible for routing messages or data between networks. The internetwork layer 105 provides a datagram network service. Datagrams are packets of information that comprise a header, data, and a trailer. The header contains information that the network needs to route the packets. Examples of header information include a destination address for the packet, a source address for the packet, and security labels. The trailer often contains a checksum to ensure that the data has not been manipulated in any improper or unauthorized manner while in transit. Another protocol that may be maintained in the internetwork layer 105 includes the Internet Control Message Protocol (ICMP). Internetwork layer 105 is also responsible for moving data between the transport layer 103 and the network interface layer 107.

Network interface layer 107 maintains the protocols for managing the exchange of data between a device and the network to which the device is coupled and for routing data between devices on the same network. Network interface layer 107 encapsulates the IP datagrams into frames that are transmitted by the network and also maps the IP addresses to the physical addresses used by the network. Network interface layer 107 adds routing information to the data received from the internetwork layer 105. This routing information is added in the form of a header field.

Each layer in the protocol stack adds control information to ensure proper delivery. Control information may include the destination address, the source address, routing controls, security labels, and checksum data. Upon reaching each layer of the stack from the application layer 101 to the network interface layer 107, the layer treats the header, data, and trailer information received from the previous layer as data and adds its own header and trailer information to the data. When a protocol uses a header and trailer to package data from another protocol, the process is called encapsulation.

FIG. 2 illustrates a block diagram of a process for encapsulating data within various layers of a protocol stack model. The original data 201 needed for transport to another computer is taken from the application layer and sent to the transport layer. At the transport layer, the original data 201 as well as control information from the application layer comprises the application layer data 211 within the transport layer. At the transport layer, a header 215 and trailer 217 may be added to the application layer data 211. Header 215, application layer data 211 and trailer 217 end up as the transport layer data 221 for the internetwork layer. At the internetwork layer, a header 225 and trailer 227 may be added to the transport layer data 221. Header 225, transport layer data 221 and trailer 227 end up as the internetwork layer data 231 for the network interface layer. At the network interface layer, a header 235 and trailer 237 may be added to the internetwork layer data 231. Header 235, internetwork layer data 231 and trailer 237 end up as the final data 241 transmitted out of the network.

As described above, an application layer 101 may include functions directed to data encryption and decryption. Application layer 101 may be included within an IPsec stack. An IPsec stack is a protocol stack including a collection of IP measures. In particular, IPsec supports authentication through a header field which verifies the validity of the originating address in the header field of every packet of a packet stream. An encapsulating security payload (ESP) header field encrypts the entire datagram based upon the encryption parameters/properties. Securing IP packets using IPsec requires a destination host computer to decrypt the received packets before being able to use the content of the packets. The decryption is implemented using a key or a set of keys and/or using some additional parameters/properties. The keys and the parameters/properties are supplied to the TCP/IP stack/architecture of the system for correct decryption of encrypted IP packets. Encryption parameters/properties are supplied by an application to an IPsec stack.

If applications must supply encryption information to the IPsec stack, the applications are more complex. A need exists to be able to keep applications using TCP/IP services simple and unaware of possible encryption of the services. A need exists for the surrounding system to be able to provide services in a decrypted form to the applications with any interface from the point of view of the application appearing as if the service is unencrypted.

### BRIEF SUMMARY OF THE INVENTION

According to aspects of the invention, a request from an application is received for IP packets associated with a first IP address/port pair. The port may be a TCP port and in one embodiment of the present invention the port is a UDP port. IP packets associated with a different IP address/port pair are also received. Decryption information is extracted from the IP packets associated with the different IP address/port pair and the IP packets associated with the first IP address/port pair, when received encrypted, are decrypted based upon the extracted decryption information. The decrypted IP packets associated with the first IP address/port pair are then transmitted to the application.

Another aspect of the invention provides a system for delivering decrypted IP packets. A TCP/IP stack is configured to receive requests for IP packets and to transmit IP packets. A packet receiver, in communication with the TCP/IP stack, is configured to receive IP packets and to transmit IP packets. An IPsec key manager, in communication with the TCP/IP stack and the packet receiver, is configured to coordinate extraction of decryption information from a first IP packet stream and transmission of the decryption information. A digital rights management component, in communication with the IPsec key manager, is configured to extract the decryption information, and an IPsec stack, in communication with the TCP/IP stack and the IPsec key manager, is configured to decrypt encrypted IP packets from a second at least partially encrypted IP packet stream based upon the decryption information. The decryption information may be independent of the application.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of a conventional example protocol stack model;

FIG. 2 illustrates a block diagram of a conventional process for encapsulating data within various layers of a protocol stack model;

FIG. 3A illustrates a block diagram of a TCP/IP stack architecture for extracting information needed for decryption of IP packets in accordance with at least one aspect of the present invention;

FIG. 3B illustrates a block diagram of a process for extracting information needed for decryption of IP packets in accordance with at least one aspect of the present invention; and

FIGS. 4A and 4B are a flow chart of an illustrative method for extracting information needed for decryption of IP packets in accordance with at least one aspect of the present invention.

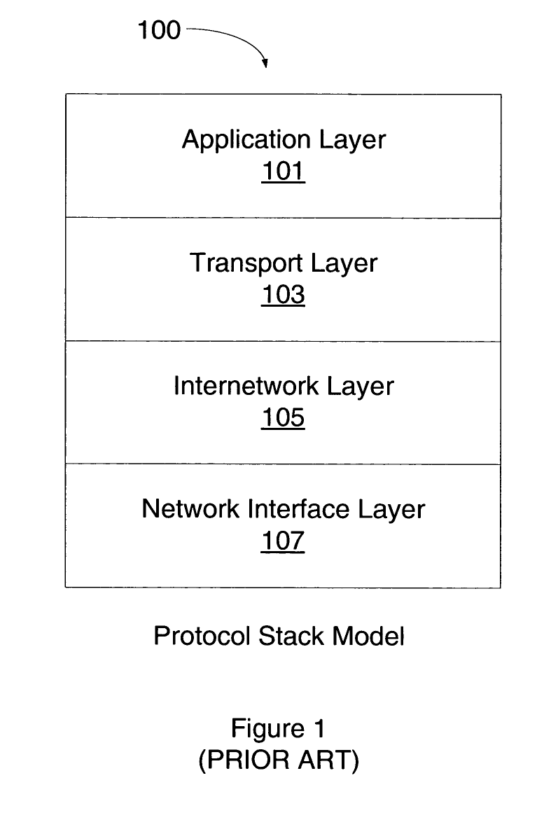

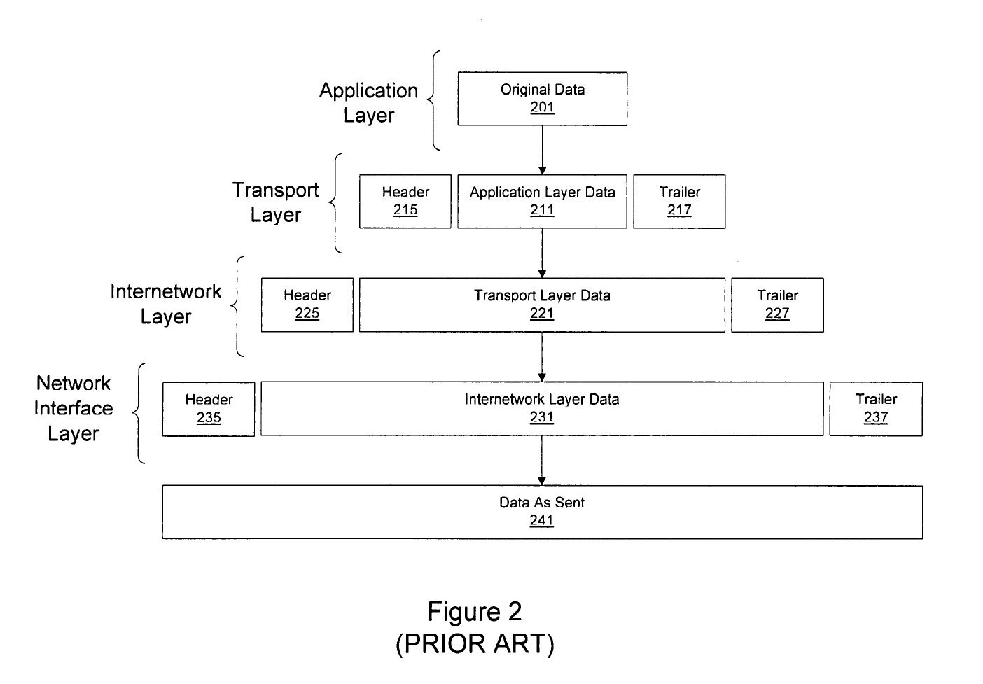

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

In accordance with aspects of the invention, a first IP address/port pair is associated with a different IP address/port pair and the key(s) and/or parameters/properties needed for decryption of the first encrypted IP data stream sent to the first IP address/port pair are sent to the different IP address/port pair. For example, a well-defined TCP port may be associated with every IP address. This well-defined port then is used as a destination port for the IPsec keys and/or parameters/properties for decrypting the packets sent to all other ports of the first IP address. The ports may be TCP or UDP type ports. In an alternative embodiment, the decryption parameters/properties and/or key(s) may be sent to the same port as the encrypted service, while the IP address of the host and destination devices are different.

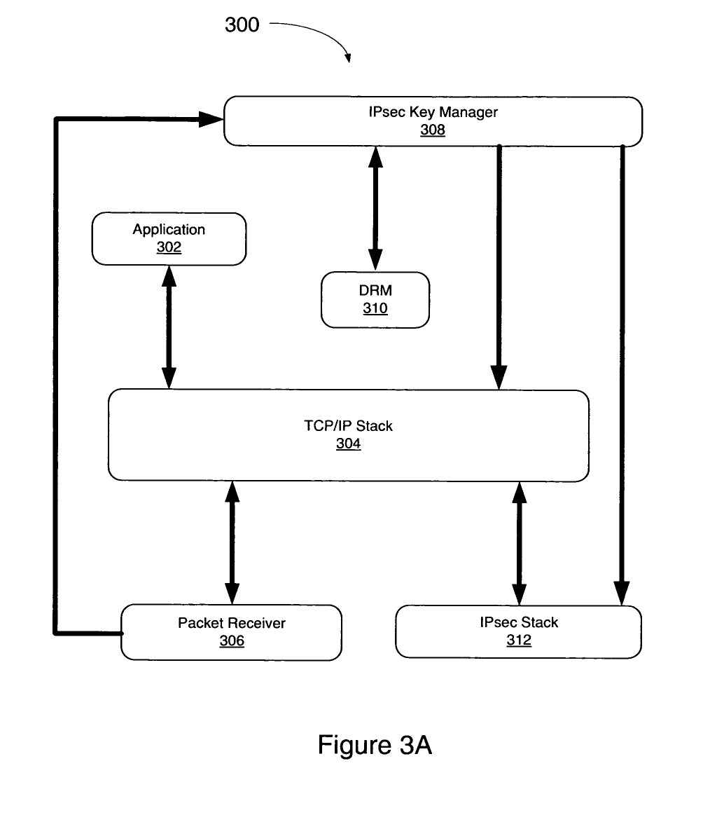

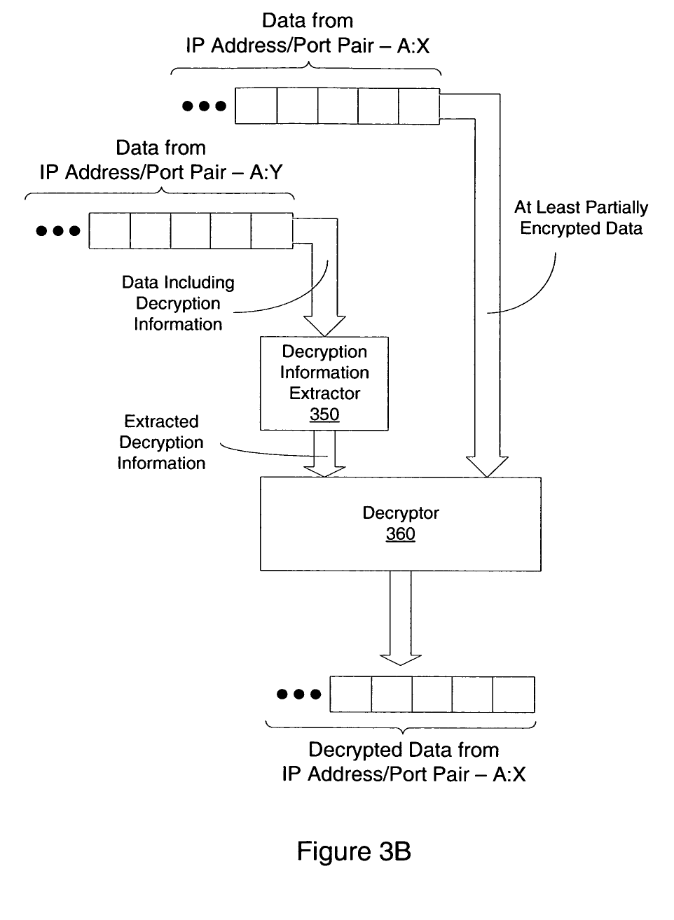

FIG. 3A illustrates a block diagram of a TCP/IP stack architecture 300 for extracting information needed for decryption of IP packets in accordance with at least one aspect of the present invention. It should be understood by those skilled in the art that the TCP/IP stack architecture illustrated in FIG. 3A is but one example and other elements and/or communication paths may be used/implemented in carrying out aspects of the present invention. For example, operations and/or functions performed by any one component, such as IPsec key manager 308 and DRM element 310 may be performed by a single component.

TCP/IP stack architecture 300 includes an application 302 that makes the initial request to receive packets from a particular IP address/TCP port pair. An IP address/TCP port pair is described herein in a configuration of an IP address, followed by a colon, followed by the TCP port. For example, an example IP address/TCP port pair may be 168.198.0.1:80. As used herein, an IP address/TCP port pair is referred to as A:X and A:Y to designate an IP address A and two different TCP ports X and Y. Application 302 has a communication link to TCP/IP stack 304. TCP/IP stack 304 is shown in communication with a packet receiver 306 for requesting and receiving IP packets from designated IP address/TCP port pairs.

TCP/IP stack 304 also is shown in communication with an IPsec stack 312. IPsec stack 312 performs decryption on encrypted IP packets received from the TCP/IP stack 304. IPsec stack 312 also returns the decrypted IP packets to the TCP/IP stack 304 upon completing decryption of the IP packets.

Packet receiver 306 is shown in communication with an IPsec key manager 308. IPsec key manager 308 is configured to cause extraction of decryption key(s) and/or properties/parameters and to forward the decryption key(s) and/or properties/parameters to the IPsec stack 312. In accordance with at least one aspect of the present invention, IPsec key manger 308 may be included within the IPsec key manager 308 component. Decryption properties/parameters may include the decryption pattern, i.e., which bits of a packet to decrypt and which bits to not decrypt, the decryption technique, i.e., the algorithm used for decryption purposes, and/or other information. IPsec key manager 308 also is in communication with a digital rights management (DRM) element 310. DRM 310 manages all rights, not only the rights applicable to permissions over digital content. These rights include usage, copying authorization and/or restriction, editing rights, and transmission rights. DRM 310 provides the IPsec key(s) and decryption parameters/properties extracted from a different TCP port, independent of the application 302. In accordance with at least one aspect of the present invention, the DRM element can be an Open Mobile Alliance (OMA) DRM component such as OMA DRM 1.0 or OMA DRM 2.0. In accordance with at least one aspect of the present invention, DRM 310 functions may be included within the IPsec key manager 308 component.

Aspects of the invention fit into existing TCP/IP stack architectures that may require additional software modules outside the existing software modules. There is no restriction on any non-encrypted IP service and applications 302 are effectively unaware of any encryption in the IP level. Aspects of the invention may be used as part of a service encryption system, e.g., when using Internet Protocol Datacast (IPDC) in Digital Video Broadcasting (DVB), its variations such as DVB-Terrestrial (DVB-T), and also in DVB-Handheld (DVB-H). In addition, aspects of the present inventions may be used in other digital video and television systems such as the U.S. Advanced Television Systems Committee (ATSC) and Japanese Integrated Services Digital Broadcasting-Terrestrial (ISDB-T) and Digital Multimedia Broadcasting-Terrestrial (DMB-T).

FIG. 3B illustrates a block diagram of a process for extracting information needed for decryption of IP packets in accordance with at least one aspect of the present invention. Data from an IP address/port pair A:Y is sent to a decryption information extractor 350. Decryption information extractor 350 may include IPsec key manager 308 and/or DRM element 310. The data from the IP address/port pair A:Y includes decryption information associated with a different IP address/port pair A:X. The decryption information extractor 350 extracts the decryption information from the data from the IP address/port pair A:Y and sends the decryption information to a decryptor 360. The decryption information may include a decryption key(s) and/or decryption properties/parameters, such as which portions to decrypt and the algorithm used for decryption. Decryptor 360 may include the IPsec key manager 308 and/or IPsec stack 312.

The decryptor 360 receives the data from the IP address/port pair A:X. The data from the IP address/port pair A:X is at least partially encrypted data. Decryptor 360 decrypts the data from the IP address/port pair A:X based upon the decryption information received from the decryption information extractor. Decryptor 360 then outputs the data from the IP address/port pair A:X in an decrypted form. This decrypted data from the IP address/port pair A:X may be sent to an application that originally requested the data. From the perspective of the application, the data requested from IP address/port pair was never encrypted.

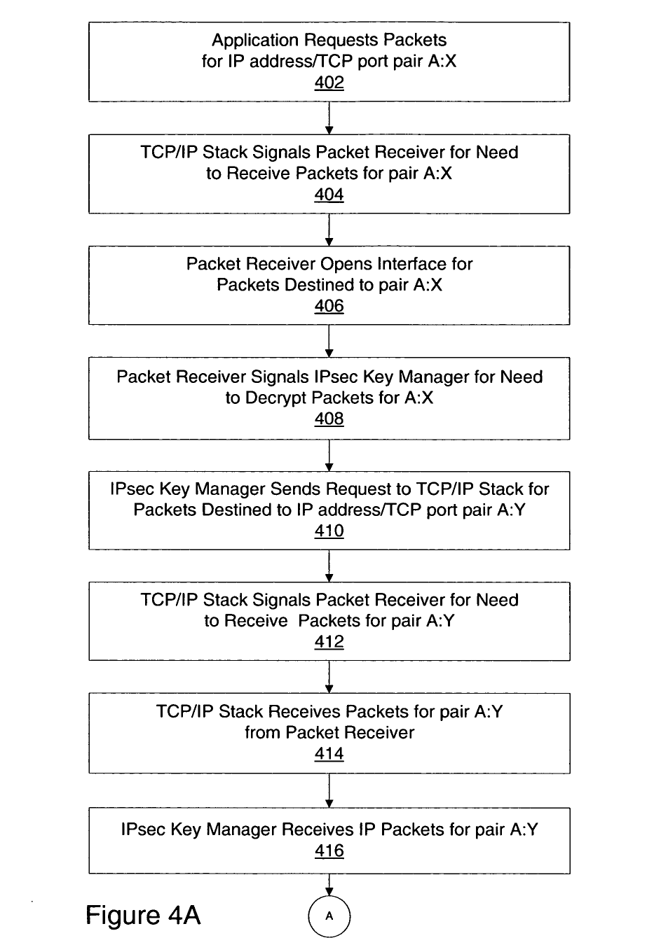

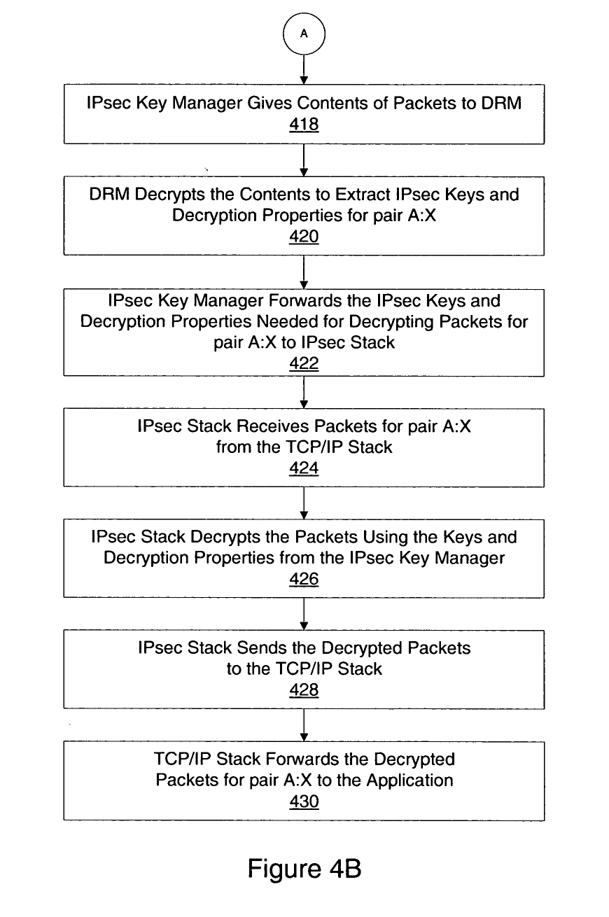

FIGS. 4A and 4B are a flow chart of an illustrative method for extracting information needed for decryption of IP packets in accordance with at least one aspect of the present invention. As shown in FIG. 4A, the process starts at step 402 when an application, such as application 302, sends a request to a TCP/IP stack for IP packets for a particular IP address/TCP port pair A:X. The TCP/IP stack may be TCP/IP stack 304. At step 404, the TCP/IP stack signals a packet receiver for the need to receive IP packets for IP address/TCP port pair A:X. The packet receiver may be packet receiver 306. The process then proceeds to step 406 where the packet receiver opens an interface for IP packets destined to IP address/TCP port pair A:X.

At step 408, the packet receiver signals an IPsec key manager for the need to decrypt IP packets for IP address/TCP port pair A:X. The IPsec key manager may be IPsec key manager 308. Upon receipt of the request from the packet receiver in step 408, the IPsec key manager sends a request to the TCP/IP stack for IP packets destined to IP address/TCP port pair A:Y at step 410. In accordance with at least one aspect of the present invention, key(s) and/or properties/parameters are maintained within a well-defined IP stream. The IPsec manager may be configured to look to a particular IP address/TCP port pair A:Y in order to obtain the necessary decryption information to decrypt the IP packets destined to IP address/TCP port pair A:X.

The process proceeds to step 412 where the TCP/IP stack signals the packet receiver for the need to receive IP packets destined to IP address/TCP port pair A:Y. IP address/TCP port pair A:Y may be a well-known IP address/port pair. At step 414, the TCP/IP stack receives the IP packets destined for IP address/TCP port pair A:Y from the packet receiver. The IPsec key manager receives the IP packets for IP address/TCP port pair A:Y at step 416. The process then continues at step 418 illustrated in FIG. 4B.

At step 418, the IPsec key manager provides the contents of the IP packets destined to IP address/TCP port pair A:Y to a digital rights management (DRM) element. The digital right management element may be DRM 310. At step 420, the DRM element receives the contents of the IP packets destined to IP address/TCP port pair A:Y and extracts IPsec key(s) and/or decryption properties/parameters for IP packets sent to IP address/TCP port pair A:X. The IPsec key manager forwards the IPsec key(s) and/or decryption properties/parameters for decryption of the IP packets destined to IP address/TCP port pair A:X to an IPsec stack at step 422. The IPsec stack may be IPsec stack 312.

The process proceeds to step 424 where the IPsec stack receives IP packets destined for IP address/TCP port pair A:X from the TCP/IP stack. Some or all of the received IP packets may be encrypted. Upon receipt of the IP packets from the TCP/IP stack, at step 426, the IPsec stack decrypts the encrypted IP packets using the key(s) and decryption properties/parameters received from the IPsec key manager in step 422. At step 428, the IPsec stack sends the decrypted IP packets to the TCP/IP stack, and at step 430, the decrypted IP packets destined for IP address/TCP port pair A:X are forwarded from the TCP/IP stack to the application. From the perspective of the application, a request for IP packets was requested and received without any indication that data was encrypted and/or decrypted in the process. Further, the application need not provide the encryption and/or decryption information used for obtaining the requested IP packets.

One or more aspects of the invention may be embodied in computer-executable instructions, such as in one or more program modules, executed by one or more computers, set top boxes, mobile terminals, or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

We claim:

1. A method for delivering decrypted Internet Protocol (IP) packets, the method comprising steps of:
receiving a request, from an application, for IP packets associated with a first IP address/port pair;
receiving IP packets associated with a different IP address/port pair;
extracting decryption information from the IP packets associated with the different IP address/port pair;
decrypting the IP packets associated with the first IP address/port pair based upon the extracted decryption information; and
transmitting the decrypted IP packets associated with the first IP address/port pair to the application.

2. The method of claim 1, wherein the IP packets associated with the first IP address/port pair are at least partially encrypted independent of the application.

3. The method of claim 1, wherein the port in the first IP address/port pair is a TCP port.

4. The method of claim 3, wherein the port in the second IP address/port pair is a TCP port.

5. The method of claim 1, wherein the port in the first IP address/port pair is a UDP port.

6. The method of claim 5, wherein the port in the second IP address/port pair is a UDP port.

7. The method of claim 1, wherein the first IP address/port pair and the different IP address/port pair include different IP addresses.

8. The method of claim 1, wherein the first IP address/port pair and the different IP address/port pair are addressed to different ports.

9. The method of claim 1, further comprising a step of associating the first IP address/port pair with at least one different IP address/port pair.

10. The method of claim 1, wherein the decryption information includes a decryption key.

11. The method of claim 10, wherein the decryption key is an IPsec key.

12. The method of claim 1, wherein the decryption information includes a decryption parameter.

13. The method of claim 1, wherein the decryption information is extracted from the IP packets associated with the different IP address/port pair independent of the application.

14. The method of claim 1, further comprising a step of transmitting a request to extract decryption information from the IP packets associated with the different IP address/port pair prior to the extracting step.

15. The method of claim 1, further comprising a step of transmitting a request to decrypt the IP packets associated with the first IP address/port pair prior to the decrypting step.

16. A computer-readable medium storing computer-executable instructions for performing the steps recited in claim 1.

17. A system for delivering decrypted IP packets, the system comprising:
a TCP/IP stack configured to receive requests for IP packets and to transmit IP packets;
a packet receiver, in communication with the TCP/IP stack, configured to receive IP packets and to transmit IP packets;
an IPsec key manager, in communication with the TCP/IP stack and the packet receiver, configured to cause decryption information to be extracted from a first IP address/port pair; and
an IPsec stack, in communication with the TCP/IP stack and the IPsec key manager, configured to decrypt encrypted IP packets from a second IP address/port pair based upon the decryption information.

18. The system of claim 17, further comprising a digital rights management component, in communication with the IPsec key manager, configured to extract the decryption information from the first IP address/port pair.

19. The system of claim 18, wherein the IPsec key manager includes the digital rights management component.

20. The system of claim 17, wherein the first and second IP address/port pairs include different IP addresses.

21. The system of claim 17, wherein the first and second IP address/port pairs are addressed to different ports.

22. The system of claim 17, further comprising an application, in communication with the TCP/IP stack, configured to request IP packets and to receive IP packets.

23. The system of claim 22, wherein the decryption information is independent of the application.

24. The system of claim 17, wherein the first and second IP address/port pairs are associated with each other.

25. The system of claim 17, wherein the decryption information includes a decryption key.

26. The system of claim 25, wherein the decryption key is an IPsec key.

27. The system of claim 17, wherein the decryption information includes a decryption parameter.

28. The system of claim 17, wherein the system is an Internet Protocol Datacast in Digital Video Broadcasting type system.

29. The system of claim 17, wherein the system is a Digital Video Broadcasting-Handheld type system.

30. The system of claim 17, wherein the system is a Digital Video Broadcasting-Terrestrial type system.

31. A system for decrypting an IP packet stream, the system comprising:
a first IP address/port pair;
a second IP address/port pair associated with the first IP address/port pair;
a means for extracting decryption information from data received at the second IP address/port pair, the decryption information being independent of the application; and
a means for decrypting at least a portion of data received at the first IP address/port pair based upon the extracted decryption information.

32. The system of claim 31, wherein the data received at the first IP address/port pair is at least partially encrypted.

33. A system for managing delivery of decryption information, the system comprising an IPsec key manager, the IPsec key manager configured:
to receive a request representative of a need to decrypt IP packets associated with a first IP address/port pair;
to request IP packets associated with a different IP address/port pair;
to obtain extracted decryption information from the IP packets associated with the different IP address/port pair; and
to transmit the extracted decryption information for use in decrypting IP packets associated with the first IP address/port pair.

34. A method for receiving encrypted IP data, comprising the steps of:
receiving from an application a request for IP packets at a given IP address/port pair;
obtaining from a different IP address/port pair information for decrypting IP packets at the given IP address/port pair;
decrypting a stream of IP packets received at the given IP address/port pair; and
providing the decrypted stream of IP packets to the application.
